(19) United States
(12) Patent Application Publication
(10) Pub. No.: US 2024/0336415 A1
(43) Pub. Date: Oct. 10, 2024

(54) IN-LINE CABLE CLIP

(71) Applicants: Sheila Vazquez, Converse, TX (US); Armin Tay, Waco, TX (US); Anthony Vu, Rockville, MD (US); Alexander Thompson, Apex, NC (US); Jagger Butler, College Station, TX (US)

(72) Inventors: Sheila Vazquez, Converse, TX (US); Armin Tay, Waco, TX (US); Anthony Vu, Rockville, MD (US); Alexander Thompson, Apex, NC (US); Jagger Butler, College Station, TX (US)

(21) Appl. No.: 18/628,780

(22) Filed: Apr. 7, 2024

Related U.S. Application Data
(60) Provisional application No. 63/458,085, filed on Apr. 7, 2023.
(60) Provisional application No. 63/458,128, filed on Apr. 9, 2023.
(60) Provisional application No. 63/552,111, filed on Feb. 10, 2024.
(60) Provisional application No. 63/552,596, filed on Feb. 12, 2024.
(60) Provisional application No. 63/553,642, filed on Feb. 15, 2024.
(60) Provisional application No. 63/553,670, filed on Feb. 15, 2024.
(60) Provisional application No. 63/554,162, filed on Feb. 16, 2024.
(60) Provisional application No. 63/561,815, filed on Mar. 6, 2024.
(60) Provisional application No. 63/562,214, filed on Mar. 6, 2024.
(60) Provisional application No. 63/566,337, filed on Mar. 17, 2024.

(51) Int. Cl. B65D 67/02

(52) U.S. Cl. CPC B65D 67/02

(57) ABSTRACT

A Clip Cable that can be used to hold cables together in an in-line and such organized manner. This allows the cables to be easily identified, and prevents the cables from getting entangled; since they will be spread-out widely so as to prevent them from twisting together. Additionally, the Cable Clip allows an individual or several individual cables to be removed and replaced, while leaving the other cables in-place. The Cable Clip allows binding cables quickly and securely, allows binding cables so that they can be identified, prevents cables from getting entangled, allows a specific cable to be easily replaced while leaving all other cables in place, and it is cheap. It saves a lot of work and time when used with thermocouples.

### CROSS-REFERENCE TO RELATED APPLICATIONS

This invention is entitled to the benefits of:
Provisional Patent Application (PPA) Ser. No. 63/458,085 filed on 7 Apr. 2023
Provisional Patent Application (PPA) Ser. No. 63/458,128 filed on 9 Apr. 2023
Provisional Patent Application (PPA) Ser. No. 63/552,111 filed on 10 Feb. 2024
Provisional Patent Application (PPA) Ser. No. 63/552,596 filed on 12 Feb. 2024
Provisional Patent Application (PPA) Ser. No. 63/553,642 filed on 15 Feb. 2024
Provisional Patent Application (PPA) Ser. No. 63/553,670 filed on 15 Feb. 2024
Provisional Patent Application (PPA) Ser. No. 63/554,162 filed on 16 Feb. 2024
Provisional Patent Application (PPA) Ser. No. 63/561,815 filed on 6 Mar. 2024
Provisional Patent Application (PPA) Ser. No. 63/562,214 filed on 6 Mar. 2024
Provisional Patent Application (PPA) Ser. No. 63/566,337 filed on 17 Mar. 2024

### BACKGROUND

### Field of Invention

This invention relates to cable clips, specifically to a cable clip that ties cables together so that they are aligned. This allows the cables to be easily identified, and

### Description of Prior Art

Zip Ties are currently used to tie cables, such as Thermocouple Cables or LAN Cables, together. Zip Ties will tie the cables together randomly and not in an organized fashion, so that they cannot be used to identify the cables that are joined together.

Additionally, when using Zip Ties, the cables tend to get entangled; since they are bound together so closely. Untangling cables is very time consuming process.

And sometimes there are instance where from a set of Thermocouple Cables that are tied together in a Zip Tie, only one Thermocouple Cable needs to replaced. This required that all Thermocouple Cables are untied, just to remove one Thermocouple.

### BRIEF SUMMARY OF THE INVENTION

A Cable Clip that can be used to hold cables together in an in-line and such organized manner. This allows the cables to be easily identified and prevent the cables from getting entangled; since they will be spread-out widely so as to prevent them from twisting together. Additionally, the Cable Clip also allows an individual or several individual cables to be removed and replaced, while leaving the other cables in-place.

Despite all of the advantages the Cable Clip provides, no such device currently exits on the market. If it was obvious, it would have been already implemented because the amount of work and time it will save; especially when used with thermocouples. The unexpected results are: it allows binding cables quickly and securely, it allows binding cables so that they can be identified, it prevents cables from getting entangled, it allows a specific cable to be easily replaced while leaving all other cables in place, and it is cheap.

### BRIEF DESCRIPTION OF THE SEVERAL VIEWS OF THE DRAWING

FIG. 1 shows a front-view of a Brace 2.

FIG. 2 shows an end-view of a Brace 2.

FIG. 3 shows a top-view of a Brace 2.

FIG. 4 shows a front-view of an End Lock 3.

FIG. 5 shows a side-view of an End Lock 3.

FIG. 6 shows a top-view of Clip 1.

FIG. 7 shows another top-view of Clip 1.

FIG. 8 also shows another top-view of Clip 1.

FIG. 9 shows a front-view of a Brace 2A.

FIG. 10 shows a top-view of a Brace 2A.

FIG. 11 shows a front-view of a Clip 1B.

FIG. 12 shows a top-view of a Clip 1B, where Rear Strap 7 and Front Strap 8 are kept together.

FIG. 13 shows a top-view of a Clip 1B; where Rear Strap 7 is sufficiently separated from Front Strap 8, so as to allow cables to be inserted between Rear Strap 7 and a Front Strap 8.

FIG. 14 shows a top-view of a Clip 1C.

FIG. 15 shows a top-view of a Clip 1D.

FIG. 16 shows a top-view of a Clip 1E.

FIG. 17 shows a front-view of a Clip 1F.

FIG. 18 shows a top-view of a Clip 1F.

FIG. 19 shows a top-view of a Clip 1G.

FIG. 20 shows a front-view of a Clip 1H.

FIG. 21 shows a top-view of a Clip 1H.

FIG. 22 shows a top-view of a Clip 1I.

FIG. 23 shows a top-view of a Clip 1I; where Rear Strap 7E is sufficiently separated from Front Strap 8E, so as to allow cables to be inserted between Rear Strap 7E and a Front Strap 8E.

FIG. 24 shows a top-view of a Clip 1J.

FIG. 25 shows a front-view of a Clip 1K.

FIG. 26 shows a top-view of a Clip 1K.

FIG. 27 shows a top-view of a Clip 1K; where Rear Strap 7G is sufficiently separated from Front Strap 8G through the use of a Hinge 21, so as to allow cables to be inserted between Rear Strap 7G and a Front Strap 8G.

FIG. 28 shows a front-view of a Clip 1L.

FIG. 29 shows a top-view of a Clip 1L.

### REFERENCE NUMERALS IN DRAWINGS

For the reference numerals in this specification; if used, the label S (number) after a label, such as S2 for example, is used to label the different shapes of a part. For example; label 1-S2, is used to label a shape designated as S2 of a part that is labeled as part 1.

### DETAILED DESCRIPTION OF THE INVENTION

### First Embodiment—Brace with End Lock

A Clip 1 is shown in FIG. 6; it is a Brace with End Lock design. It comprises of a Brace 2 and an End Lock 3.

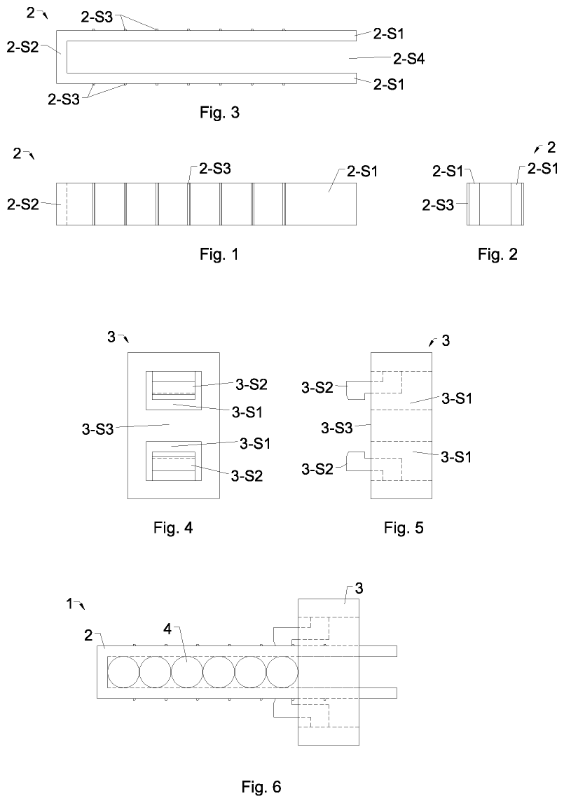

Brace 2 is shown by itself in FIGS. 1 to 3. It has two parallel Side Straps 2-S1 that are joined at one end by an End Wall 2-S2. Each Side Strap 2-S1 has Side Strap Teeth 2-S3, which are used to engage with an End Lock Tooth 3-S2 of an End Lock 3. Brace 2 also has an Open-End 2-S4, into which Cables 4 can be inserted.

End Lock 3 is shown in FIGS. 4 and 5. It is shaped like a rectangle that has two rectangular Holes 3-S1. Each Hole 3-S1 is used for inserting a Side Strap 2-S1 of Brace 2. Mounted on each Hole 3-S1 is an End Lock Tooth 3-S2. Each End Lock Tooth 3-S2 engages with the Side Strap Side Strap Teeth 2-S3 of the Side Strap 2-S1 that is inserted into its Hole 3-S1. The material between Holes 3-S1 is labeled as Cable Engagement Surface 3-S3.

In order to use Clip 1 to hold Cables 4 together in an in-line manner (see FIG. 6), first Cables 4 are inserted into Open-End 2-S4 of Brace 2. Once all Cables 4 that are to be held together by Clip 1 have been inserted into Brace 2, the “ends of Side Straps 2-S1 at Open-End 2-S4” are each inserted into a Hole 3-S1 of End Lock 3. And then End Lock 3 is slid towards End Wall 2-S2 of Brace 2, until Cable Engagement Surface 3-S3 of End Lock 3 engages with the “Cable 4 that is located adjacent to Open-End 2-S4”; and End Lock Teeth 3-S2 of End Lock 3 engage with the Side Strap Teeth 2-S3 of Side Straps 2-S1 that will keep the “Cable 4 that is located adjacent to Open-End 2-S4” engaged with Cable Engagement Surface 3-S3 of End Lock 3.

It is preferred that Side Strap Teeth 2-S3 of Side Straps 2-S1 are spaced evenly so that they are positioned such that End Lock 3 can lock in: the minimum amount of Cable(s) 4 to the maximum amount of Cables 4 that Clip 1 is designed to hold together; in manner so that “the Cable 4 adjacent to Open-End 2-S4” is engaged with “Cable Engagement Surface 3-S3 of End Lock 3” once End Lock Teeth 3-S2 of End Lock 3 engage with the Side Strap Teeth 2-S3 of Side Straps 2-S1 that will keep “the Cable 4 adjacent to Open-End 2-S4” engaged with “Cable Engagement Surface 3-S3 of End Lock 3”.

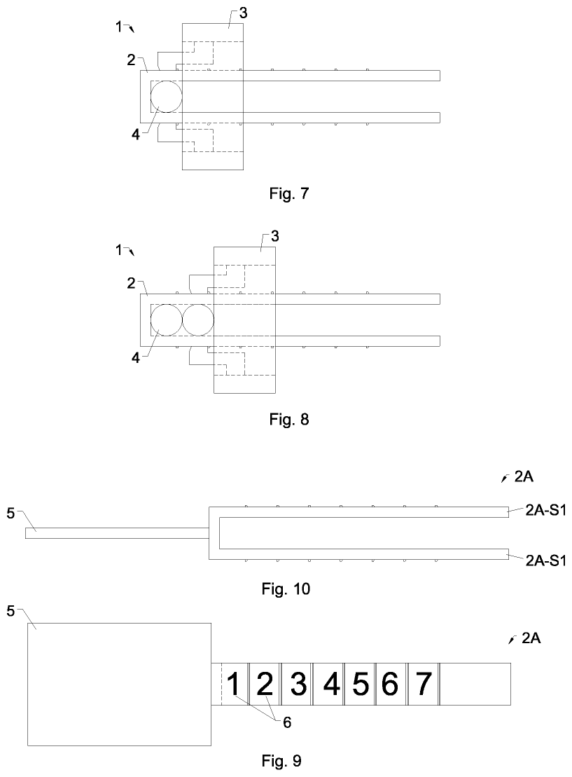

In other words; it is preferred that the purpose of each Side Strap Tooth 2-S3 of each Side Strap 2-S1, is to engage with an End Lock Tooth 3-S2 of End Lock 3, so as to lock in the inserted Cable(s) 4 in a manner so as to keep “the Cable 4 adjacent to Open-End 2-S4” engaged with Cable Engagement Surface 3-S3; also refer to FIGS. 7 and 8.

FIGS. 9 and 10, show a Brace 2A that can be used to replace a Brace 2 for a Clip 1. Brace 2A is identical to Brace 2, except that it has a Tag Surface 5, and Identification Labels 6 labeled on at least one of its Side Straps 2A-S1. Each Identification Label 6 is positioned so that a Cable 4 can be identified by it; such as positioned in front of a Cable 4 for example. Identification Labels 6 can be numbers, letters, etc. And Tag Surface 5 can be used to identify the Cables 4 within the clip, such as Thermocouples #6 to #12 for example. Tag Surface 5 can also be prelabeled, such as 1:_, 2:_, 3:_, etc.

Tag Surface 5 and Identification Labels 6 are optional and can be used without each other. For example, Tag Surface 5 can be used by itself, or Identification Labels 6 can be used by themselves.

### Second Embodiment—Clamping Clip with Indexed Cavities

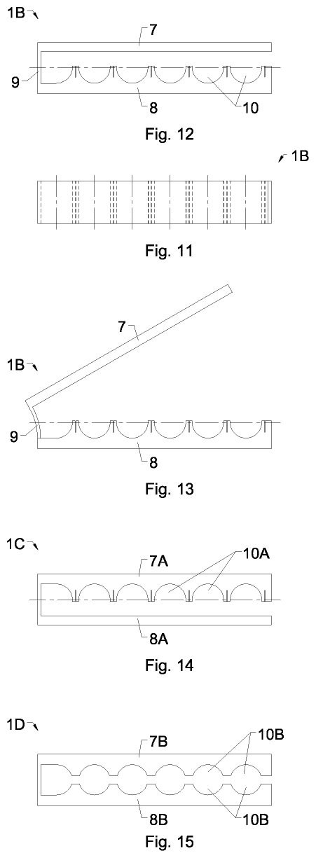

A Clip 1B is shown in FIGS. 11 to 12. Clip 1B has a Rear Strap 7 and a Front Strap 8 that are joined at one end by an End Wall 9. Rear Strap 7, Front Strap 8, and/or End Wall 9 should be flexible enough so that Rear Strap 7 can be sufficiently separated from Front Strap 8 so as to allow cables to be inserted between Rear Strap 7 and a Front Strap 8 (see FIG. 13).

It is preferred that End Wall 9 provides all or most of the flexibility to allow Rear Strap 7 to be sufficiently separated from Front Strap 8; since a stiff Rear Strap 7 and a stiff Front Strap 8 will clamp the cables inserted into Clip 1B better.

Front Strap 8 has Cavities 10. Cavities 10 are used to laterally separate each cable inserted into Clip 1B; as such, each said Cavity should be shaped so that it can laterally contain a separate cable. Cavities 10 allow individual cables to be removed, while leaving the other cables in place. And Cavities 10 also allows Clip 1B to hold less than the maximum amount of cables that Clip 1B can hold.

Cavities 10 are an essential feature of Clip 1B; they can be shaped on either Rear Strap 7 only, Front Strap 8 only, or both. But at least Rear Strap 7 or Front Strap 8 should have Cavities 10 shaped on them.

For Clip 1B, Cavities 10 are shaped on Front Strap 8. And FIG. 14 shows a Clip 1C for which its Cavities 10A are shaped on its Rear Strap 7A instead of its Front Strap 8A; and FIG. 15 shows a Clip 1D for which its Cavities 10B are shaped on both its Rear Strap 7B and its Front Strap 8B.

It is preferred that only a Rear Strap or a Front Strap has Cavities shaped on them, such is the case for Clip 1B (see FIG. 12) and Clip 1C (see FIG. 14). The advantage of this is described for Clip 1B in the following 2 paragraphs below; the same advantage also applies to Clip 1C.

When only Rear Strap 7 or Front Strap 8 of Clip 1B has Cavities 10 shaped on them (see FIG. 12), Cavities 10 can cover slightly more than half of the circumference of the cables to be inserted into them; so that they can grip the cables inserted into them. This will keep the cables in place when Rear Strap 7 is separated from Front Strap 8 (see FIG. 13), and help prevent the Clip 1B from sliding relative to its cables along the length of the cables.

But this is not absolutely necessary, since the cables are held in place by Rear Strap 7 and Front Strap 8 when they are not separated (see FIG. 12). Without Rear Strap 7 and Front Strap 8, the cables can easily become loose; especially if thermocouple cables are used. Since thermocouple cables have a greater width than height, since they consist of two separate cables are joined together; so that twisting of a thermocouple cable would unlock that a cable from its cavity, even if that cavity covers slightly more than half of the circumferences of the separate cables of that thermocouple cable (see FIG. 19 for Cavities 10C for thermocouple cables). So for practical purposes, Rear Strap 7 and Front Strap 8 are absolutely necessary.

And not all cavities have to be shaped identically; for example, the cavity adjacent to End Wall 9 can be shaped differently (see FIGS. 12, 14, and 15).

In order to keep Rear Strap 7 and Front Strap 8 together as shown in FIG. 12; the stiffness of End Wall 9 can be used.

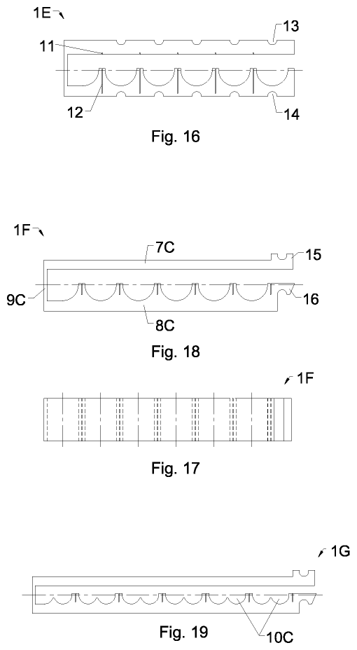

A Clip 1E is shown in FIG. 16; it identical to Clip 1B, except for the differences described below. Clip 1E has Cuts 11 and Cuts 12 shaped along its length so that it can be cut to length as required. For example, a Clip 1E that has six cavities can be cut so that it only has two cavities. Preferably but not necessarily, the cuts are made using a specialized tool similar to a paper cutter; in order to maintain the decreased-width-advantage that this design provides.

A Clip 1F is shown in FIGS. 17 and 18; it is identical to Clip 1E, except that it has a means for looking and unlocking its Rear Strap 7C relative to its Front Strap 8C at its open end, which is the end opposite of its End Wall 9C. For the Clip 1F shown, as a means for looking and unlocking Rear Strap 7C relative to Front Strap 8C at its open end, Rear Strap 7C has a Clamping Surface 15 and Front Strap 8C has a Clamping Surface 16.

Clamping Surface 15 and Clamping Surface 16 each have an indentation for a rubber band, so that a rubber band can be used to lock Clamping Surface 15 and Clamping Surface 16 together; so as to lock Rear Strap 7C to Front Strap 8C. And to unlock Rear Strap 7C from Front Strap 8C, the “rubber band used” can simply be removed.

A Clip 1G is shown in FIG. 19; it is identical to Clip 1F, except that its cavities, which are labeled as Cavities 10C, are for thermocouples instead of regular cables.

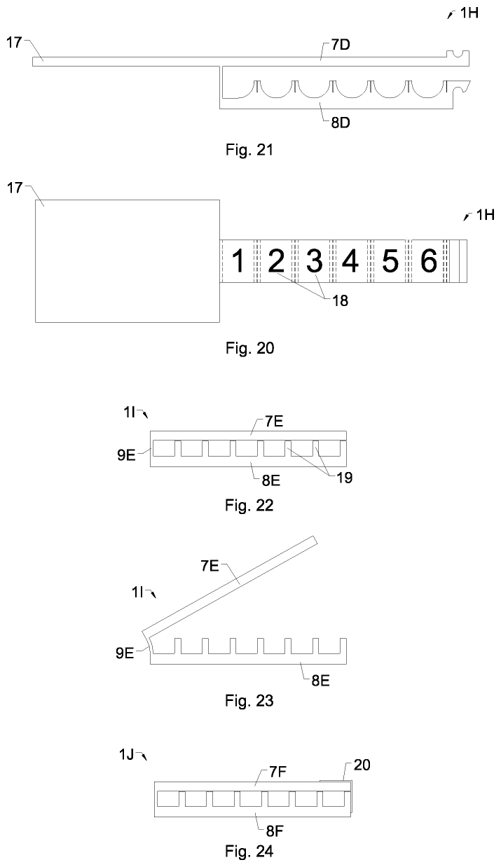

A Clip 1H is shown in FIGS. 20 to 21. Clip 1H is identical to Clip 1F, except that it has a Tag Surface 17, and Identification Labels 18, for identifying each cable, marked on its Rear Strap 7D and/or its Front Strap 8D.

Each Identification Label 18 is positioned so that a cable can be identified by it; such as positioned in front of a cable for example. Identification Labels 18 can be numbers, letters, etc. And Tag Surface 17 can be used to identify the cables within Clip 1H, such as Thermocouples #6 to #12 for example. Or Tag Surface 18 can be prelabeled, such as 1:_, 2:_, 3:_, etc.

### Third Embodiment—Clamping Clip with Compartments

A Clip 1I is shown in FIG. 22; it is identical to Clip 1B, except that its cavities are compartments. These compartments do not have a dimension for a specific cable; but are preferably large enough to be able to hold one or several generic household cable(s) (printer cable, audio cable, power supply cable, etc.).

Clip 1I has a Rear Strap 7E and a Front Strap 8E that are joined at one end by an End Wall 9E. Rear Strap 7E, Front Strap 8E, and/or End Wall 9E should be flexible enough so that Rear Strap 7E can be sufficiently separated from Front Strap 8E so as to allow cables to be inserted between Rear Strap 7E and a Front Strap 8E (see FIG. 23).

It is preferred that End Wall 9E provides all or most of the flexibility to allow Rear Strap 7E to be sufficiently separated from Front Strap 8E. And in order to keep Rear Strap 7E and Front Strap 8E together as shown in FIG. 22; the stiffness of End Wall 9 can be used to force Rear Strap 7E towards Front Strap 8E.

Front Strap 8E has Compartment Walls 19 shaped on it (see FIG. 22). Compartment Walls 19 are used to separate the space between Rear Strap 7E and Front Strap 8E into several compartments. The purpose of the compartments, and hence also Compartment Walls 19, is to laterally contain one or several cables that are inserted into Clip 1I.

A Clip 1J is shown in FIG. 24; it identical to Clip 1I, except that here a Sticker 20 is used to secure its Rear Strap 7F to its Front Strap 8F.

### Fourth Embodiment—Hinged Clip with Indexed Cavities

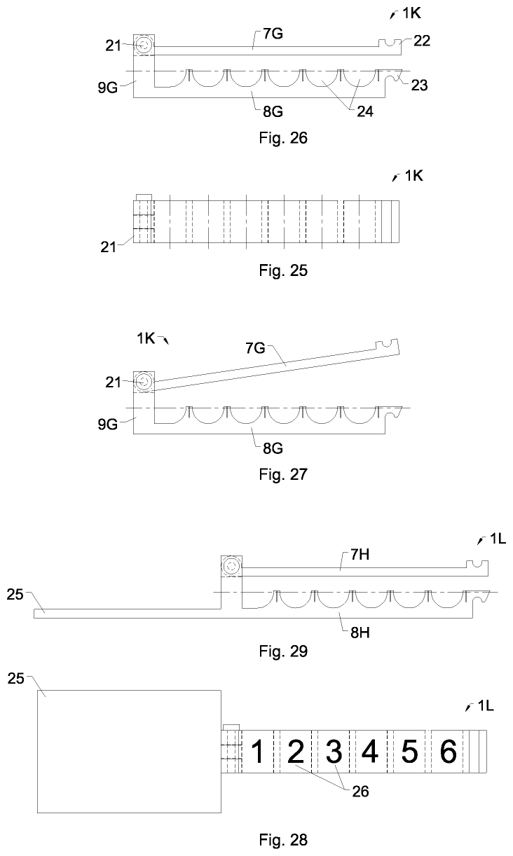

A Clip 1K is shown in FIGS. 25 to 26; it is identical to Clip 1F; except that it uses a Hinge 21 in order to allow for an opening between its Rear Strap 7G and its Front Strap 8G so that cables can be inserted between them (see FIG. 27).

A Clip 1K has a Rear Strap 7G and a Front Strap 8G that are joined at one end by an End Wall 9G, which has a Hinge 21. Hinge 21 allows Rear Strap 7G to pivot relative to Front Strap 8G.

And Clip 1K also has a means for looking and unlocking its Rear Strap 7G relative to its Front Strap 8G at its open end, which is the end opposite of its End Wall 9G. For the Clip 1K shown, as a means for looking and unlocking Rear Strap 7G relative to Front Strap 8G at its open end, Rear Strap 7G has a Clamping Surface 22 and Front Strap 8G has a Clamping Surface 23 (see FIG. 26).

Front Strap 8G has Cavities 24. Cavities 24 are used to laterally separate each cable inserted into Clip 1K; as such, each said Cavity should be shaped so that it can laterally contain a separate cable. Cavities 24 allow individual cables to be removed, while leaving the other cables in place. And Cavities 22 also allows Clip 1K to hold less than the maximum amount of cables that Clip 1K can hold.

If desired, Cavities 24 can be shaped on Rear Strap 7G instead of on Front Strap 8G. But it is preferred that only Rear Strap 7G or Front Strap 8G has Cavities 24 shaped on them. Since this allows the Cavities 24 to cover slightly more than half of the circumference of the cables to be inserted into them; so that they can lightly grip the cables inserted into them. But this is not absolutely necessary.

And not all cavities have to be shaped identically; for example, the cavity adjacent to End Wall 9G can be shaped differently (see FIG. 26).

A Clip 1L is shown in FIGS. 28 to 29. Clip 1L is identical to Clip 1K, except that it has a Tag Surface 25, and Identification Labels 26, for identifying each cable, marked on its Rear Strap 7H and/or its Front Strap 8H.

Each Identification Label 26 is positioned so that a cable can be identified by it; such as positioned in front of a cable for example. Identification Labels 26 can be numbers, letters, etc. And Tag Surface 25 can be used to identify the cables within Clip 1L, such as Thermocouples #6 to #12 for example. Or Tag Surface 25 can be prelabeled, such as, 1:_, 2:_, 3:_, etc.

### PREFERRED EMBODIMENT OF THE INVENTION (BEST MODE)

The preferred embodiment of the invention is Clip 1H which is described in the “Second Embodiment-Clamping Clip with Indexed Cavities” section of this disclosure.

### CONCLUSION, RAMIFICATIONS, AND SCOPE

While my above description contains many specificities, these should not be construed as limitations on the scope, but rather as an exemplification of one or several embodiment(s) thereof. Many other variations are possible.

Accordingly, the scope should be determined not by the embodiment(s) illustrated, but by the appended claims and their legal equivalents.

I claim:

1. A Clip (1) for Cables (4) that can be used to tie cables together in an in-line and such organized manner, comprising:
a) a Brace (2); said Brace (2) has two parallel Side Straps (1-S1) that are joined at one end by an End Wall (1-S2);
each said Side Strap (2-S1) has Side Strap Teeth (2-S3), which are used to engage with an End Lock Tooth (3-S2) of an End Lock (3);
said Brace 2 also has an Open-End 1-S4, into which said Cables (4) can be inserted;
b) said End Lock (3); said End Lock (3) has two Holes (3-S1);
each said Hole (3-S1) is used for inserting one of said two parallel Side Straps (2-S1);
mounted on each said Hole (3-S1) is a said End Lock Tooth (3-S2); each said End Lock Tooth (3-S2) engages with the said Side Strap Teeth (2-S3) of the said Side Strap (2-S1) that is inserted into its said Hole (3-S1);
the material between said Holes (3-S1) is labeled as Cable Engagement Surface (3-S3).

2. The Clip (1) of claim 1 wherein said Side Strap Teeth (2-S3) of said Side Straps (2-S1) are spaced evenly so that they are positioned such that said End Lock (3) can lock in the minimum amount of said Cable(s) (4) to the maximum amount of said Cables (4) that said Clip (1) is designed to hold together; in manner so that the said Cable (4) adjacent to said Open-End (2-S4) is engaged with said Cable Engagement Surface (3-S3) of said End Lock (3) once said End Lock Teeth (3-S2) of said End Lock (3) engage with the said Side Strap Teeth (2-S3) of said Side Straps (2-S1) that will keep the said Cable (4) adjacent to said Open-End (2-S4) engaged with said Cable Engagement Surface (3-S3) of said End Lock (3).

3. The Clip (1) of claim 2 wherein said Brace (2) is replaced with a Brace (2A);
said Brace (2A) is identical to said Brace (2), except that it has a Tag Surface (5), and Identification Labels (6) labeled on at least one of its said Side Straps (2A-S1).

4. A Clip (1B) for cables that can be used to tie cables together in an in-line and such organized manner, comprising:
a) a Rear Strap (7);
b) a Front Strap (8);
c) an End Wall (9),
said Rear Strap (7), said Front Strap (8), and/or said End Wall (9) should be flexible enough so that Rear Strap (7) can be sufficiently separated from Front Strap (8) so as to allow cables to be inserted between Rear Strap (7) and a Front Strap (8);
d) Cavities (10), said Cavities (10) are used to laterally separate each cable inserted into said Clip (1B), each said Cavity (10) should be shaped so that it can laterally contain a separate cable;
said Cavities (10) are shaped on either Rear Strap (7) only, Front Strap (8) only, or both; but at least said Rear Strap (7) or said Front Strap (8) should have Cavities (10) shaped on them.

5. The Clip (1B) of claim 4 wherein only said Rear Strap (7) or said Front Strap (8) has Cavities (10);
And wherein said Cavities (10) cover slightly more than half of the circumference of the cables to be inserted into them; so that they can lightly grip the cables inserted into them.

6. The Clip (1F) of claim 5 wherein said Rear Strap (7C) has a Clamping Surface (15) and said Front Strap (8C) has a Clamping Surface (16).

7. The Clip (1F) of claim 6 wherein said Clamping Surface (15) and Clamping Surface (16) each have an indentation for a rubber band.

8. The Clip (1H) of claim 7 wherein said Clip (1H) has a Tag Surface (17) and Identification Labels (18), for identifying each cable, marked on said Rear Strap (7D) and/or said Front Strap (8D);
each said Identification Label (18) is positioned so that a cable can be identified by it;
and said Tag Surface (17) can be used to identify the cables within said Clip (1H).
